(19) United States
(12) Patent Application Publication
(10) Pub. No.: US 2019/0068361 A1
(43) Pub. Date: Feb. 28, 2019

(54) IN-VEHICLE GROUP KEY DISTRIBUTION

(71) Applicant: FORD GLOBAL TECHNOLOGIES, LLC, Dearborn, MI (US)

(72) Inventors: Xin YE, Farmington Hills, MI (US); Jason Michael MILLER, Woodhaven, MI (US); Piyush I. PATEL, Canton, MI (US)

(21) Appl. No.: 15/690,435

(22) Filed: Aug. 30, 2017

(51) Int. Cl. H04L 9/08; H04L 29/06

(52) U.S. Cl. CPC H04L 9/083; H04L 9/0869; H04L 9/0894; H04L 9/0877; H04L 2209/84; H04L 63/0428

(57) ABSTRACT

A gateway including a hardware security module (HSM) implementing a hardware random number generator and a non-transitory memory maintaining a key injection status table (KIST). The gateway is programmed to distribute keys generated using the random number generator to a plurality of electronic control units (ECUs) responsive to a trigger to begin key distribution received from an end-of-line (EOL) tool, and send the KIST to the EOL tool responsive to completion of the key distribution. A key generated using a hardware random number generator is sent in an encrypted message to a vehicle electronic control unit (ECU), responsive to receiving a unique identifier (UID) of the ECU over a vehicle bus. Responsive to an indication of success from the ECU in a second encrypted message, a key injection status table (KIST) is updated to indicate that the key was applied to the ECU.

### TECHNICAL FIELD

Aspects of the disclosure relate to secure distribution of cryptographic keys to in-vehicle on-board electronics control units (ECUs) during vehicle assembly.

### BACKGROUND

Symmetric-key algorithms are algorithms for cryptography that use the same cryptographic keys for both encryption of plaintext and decryption of ciphertext. The keys may be identical or there may be a simple transformation to go between the two keys. A vehicle bus is a specialized internal communications network that interconnects components inside a vehicle. Special requirements for vehicle control such as assurance of message delivery, of non-conflicting messages, of minimum time of delivery, of low cost, and of EMF noise resilience, as well as redundant routing and other characteristics mandate the use vehicle-specific communication protocols. As vehicles become more reliant on internal communications between components, secure messaging between the components becomes a greater priority in the design and implementation of in-vehicle communications systems.

### SUMMARY

In one or more illustrative embodiments, a system includes a gateway including a hardware security module (HSM) implementing a hardware random number generator and a non-transitory memory maintaining a key injection status table (KIST), programmed to distribute keys generated using the random number generator to a plurality of electronic control units (ECUs) responsive to a trigger to begin key distribution received from an end-of-line (EOL) tool, and send the KIST to the EOL tool responsive to completion of the key distribution.

In one or more illustrative embodiments, a method includes sending a key generated using a hardware random number generator in an encrypted message to a vehicle electronic control unit (ECU), responsive to receiving a unique identifier (UID) of the ECU over a vehicle bus; and responsive to an indication of success from the ECU in a second encrypted message, updating a key injection status table (KIST) to indicate that the key was applied to the ECU.

In one or more illustrative embodiments, a system includes a processor programmed to, responsive to an indication of success from an ECU in an encrypted response message received responsive to sending a key generated using a hardware random number generator in an encrypted request message to the ECU, update a key injection status table (KIST) to indicate that the key was applied to the ECU.

### BRIEF DESCRIPTION OF THE DRAWINGS

FIG. 1 illustrates an example system topology for providing communication between a plurality of ECUs of a vehicle;

FIG. 2 illustrates an example implementation of an on-vehicle telematics protocol (OVTP) stack;

FIG. 3 illustrates an example process for performing the secure key distribution; and

FIG. 4 illustrates an example data flow diagram for performing the secure key distribution.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Distributing symmetric keys to different ECUs is a pre-requisite to secure on-board communication amongst ECUs within a vehicle. These secure communications may include, as some examples, message authentication and encryption on various types of in-vehicle networks (such as controller area network (CAN), CAN-FD, Ethernet, etc.). Distributing keys in a secure manner is, however, usually a complicated task. A baseline requirement is that keys should be generated independently for different vehicles. This requirement reflects the basic principle that if a key is compromised on one vehicle, that compromised key does not affect the security of any other vehicles. A second general security requirement is that the generated keys shall maintain a certain amount of entropy. For instance, keys of AES-128 should be generated to have 128-bit entropy. Ensuring a sufficient amount of entropy requires dedicated hardware-based true random number generation.

Key distribution may be performed at the vehicle assembly line to provide for secure communications between ECUs in built vehicles. To do so requires meeting multiple constraints such as network connectivity, cycle time, and vehicle build plant processes. As explained in detail herein, a key distribution protocol is proposed that meets these security objectives while minimizing the impact on existing vehicle assembly processes.

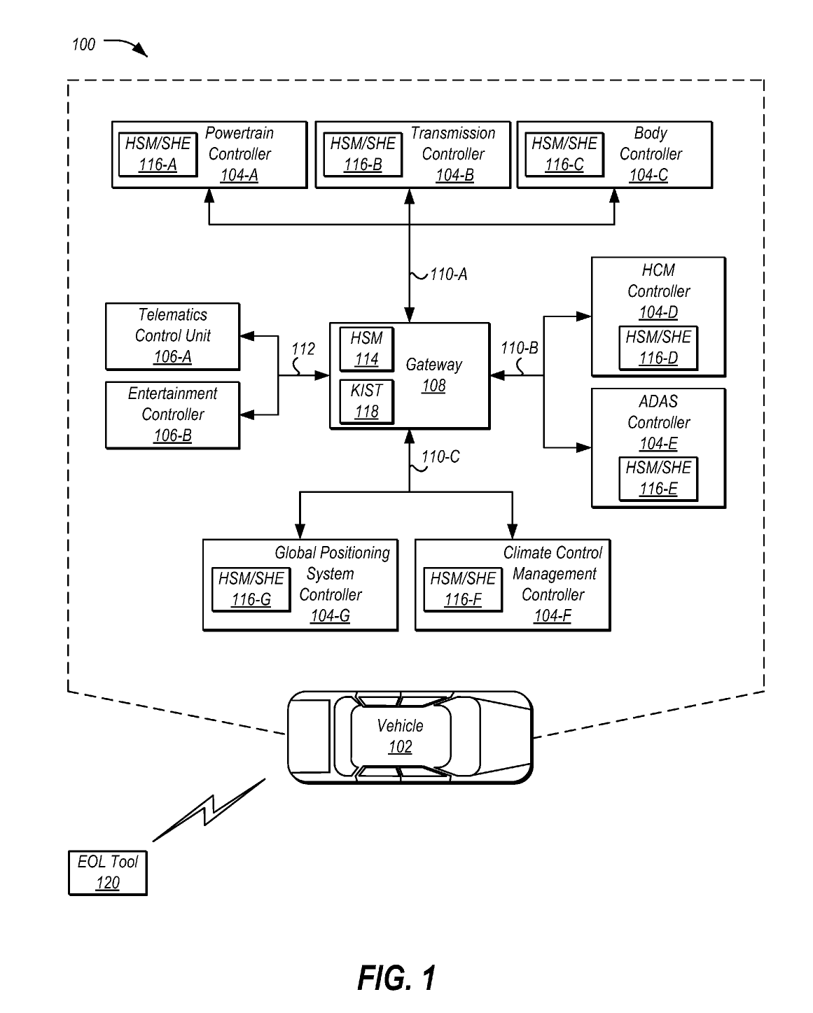

FIG. 1 illustrates an example system topology 100 for providing communication between a plurality of ECUs 104 of a vehicle 102. Each ECU 104 is connected to one of a plurality of subnets 110. A telematics control unit (TCU) 106-A and a vehicle entertainment controller 106-B are configured (together or separately) to facilitate communication between various components of the vehicle 102 and those of other vehicles 102 and/or mobile devices via external and in-vehicle networks (not shown). The TCU 106-A and the entertainment controller 106-B (hereinafter, backbone controllers 106) may be connected to a backbone 112 portion of the system topology 100 and may communicate with each other and/or with the ECUs 104. While an example system topology 100 is shown in FIG. 1, the example components as illustrated are not intended to be limiting. Indeed, the system topology 100 may have more or fewer components, and additional or alternative components and/or implementations may be used. As an example, the ECUs 104 and the backbone controllers 106 may each be connected to one or more same or different types of nodes as the subnets 110 and the backbone 112.

The vehicle 102 may be, for example, various types of automobile, crossover utility vehicle (CUV), sport utility vehicle (SUV), truck, recreational vehicle (RV), boat, plane or other mobile machine for transporting people or goods. In many cases, the vehicle 102 may be powered by an internal combustion engine. As another possibility, the vehicle 102 may be a hybrid electric vehicle (HEV) powered by both an internal combustion engine and one or more electric motors, such as a series hybrid electric vehicle (SHEV), a parallel hybrid electrical vehicle (PHEV), or a parallel/series hybrid electric vehicle (PSHEV). As the type and configuration of vehicle 102 may vary, the operating characteristics of the vehicle may correspondingly vary. As some other possibilities, the vehicle 102 may have different characteristics with respect to passenger capacity, towing ability and capacity, and storage volume.

The ECUs 104 may include various hardware and software components and may be configured to monitor and manage various vehicle functions under the power of the vehicle 102 battery and/or drivetrain. The ECUs 104 may, accordingly, include one or more processors (e.g., microprocessors) (not shown) configured to execute firmware or software programs stored on one or more storage devices (not shown) of the ECUs 104. While the ECUs 104 are illustrated as separate components, the vehicle ECUs 104 may share physical hardware, firmware, and/or software, such that the functionality from multiple ECUs 104 may be integrated into a single ECU 104, and that the functionality of various such ECUs 104 may be distributed across a plurality of ECUs 104.

The ECUs 104 may include a powertrain controller 104-A configured to manage operating components related to one or more vehicle sources of power, such as engine, battery, and so on, a transmission controller 104-B configured to manage power transfer between vehicle powertrain and wheels, a body controller 104-C configured to manage various power control functions, such as exterior lighting, interior lighting, keyless entry, remote start, and point of access status verification, a headlamp control module (HCM) 104-D configured to control light on/off settings, mobile devices, or other local vehicle 102 devices, advanced driver assistance systems (ADAS) 104-E such as adaptive cruise control or automate braking, a climate control management controller 104-F configured to monitor and manage heating and cooling system components (e.g., compressor clutch, blower fan, temperature sensors, etc.), and a global positioning system (GPS) controller 104-G configured to provide vehicle location information. It should be noted that these are merely examples, and vehicles 102 may include more, fewer, or different ECUs 104 may be used.

The backbone controllers 106, e.g., the TCU 106-A and the entertainment controller 106-B, may each include one or more processors (not shown) (e.g., microprocessors) configured to execute firmware or software programs stored on one or more respective storage devices of the TCU 106-A and the entertainment controller 106-B.

The TCU 106-A may include a modem or other network hardware to facilitate communication between the vehicle 102 and one or more networks external to the vehicle 102. These external networks may include the Internet, a cable television distribution network, a satellite link network, a local area network, a wide-area network, and a telephone network, as some non-limiting examples.

The entertainment controller 106-B may be configured to support a voice command interface with vehicle occupants as well as local-area connection interfaces with carry-on devices of the vehicle occupants. In an example, the entertainment controller 106-B may be configured to communicate with the carry-on devices via one or more of BLUETOOTH, Wi-Fi, and wired USB network connections. These connections may be used to facilitate data transmission with carry-on devices configured to communicate with one or more of the external network. As one possibility, the entertainment controller 106-B may be a controller of the FORD SYNC system provided by FORD MOTOR COMPANY of Dearborn, Mich.

The vehicle 102 may include gateway 108. In an example, the gateway 108 may implement functionality of a smart data link connector (SDLC). The gateway 108 may be configured to facilitate data exchange between vehicle ECUs 104. The gateway 108 may be further configured to facilitate data exchange between the vehicle ECUs 104 and the one or more backbone controllers 106 located on the backbone 112. In an example, the vehicle ECUs 104 and the backbone controllers 106 may communicate with the gateway 108 using CAN communication protocol, such as, but not limited to, a high-speed (HS) CAN, a mid-speed (MS) CAN, or a low-speed (LS) CAN. Different subnets 110 may utilize different CAN protocol speeds. In an example, one or more of the subnets may implement HS-CAN, while one or more other subnets 110 may implement MS-CAN. In yet other examples, the gateway 108 may be configured to facilitate communication using one or more of an Ethernet network, a media oriented system transfer (MOST) network, a FlexRay network, or a local interconnect network (LIN).

One or more of the subnets 110 may define a main subnet, which may be referred to as a backbone 112. The backbone 112 may include a portion of the system topology 100 configured to serve as a joining point of communication for the other subnets 110 of the vehicle 102. Accordingly, the backbone 112 may be configured to manage and route data traffic in a greater volume than that provided via the other subnets 110. Using the message processing features of the gateway 108, the gateway 108 may be configured to transmit message frames between the backbone controllers 106 located on the backbone 112 and the one or more of the vehicle ECUs 104 located on the other subnets 110.

The gateway 108 may be configured to identify on which subnet 110 each of the ECUs 104, 106 is located. This may be accomplished according to a corresponding physical network address of the ECUs 104, 106. In an example, in response to receiving a request to route a message to a given ECU 104, 106, the gateway 108 may query a storage to identify a network address corresponding to the ECU 104, 106. For instance, the gateway 108 may include a storage configured to store the network addresses, as well as, a routing schema defining which messages are routed to which subnets 110 and/or backbone 112. This routing may be determined by the gateway 108 based on predefined parameters included in the message, such as a type of message, and/or identifiers of the ECUs 104, 106 that designate the source and/or target of the message.

Using the system topology 100 illustrated in FIG. 1, integrated key distribution may take place at a vehicle assembly plant. This may be referred to as being performed at the vehicle operation (VO) stage. The integrated key distribution may establish a trust relationship among different groups of ECUs 104 on the same vehicle 102, which may enable authenticated communication among the ECUs 104. To minimize effects on the VO process at prerolls, and at dynamic and static end-of-line (EOL) stations, the process is initiated at prerolls with a simple diagnostic request and works in the background while the key is in the ON position.

An EOL tool 120 may connect to the vehicle 102, in an example, via an on-board diagnostic (OBD) port or other connection to the messaging of the vehicle 102. The process may, accordingly, be completed by the end of the static EOL station, where the EOL tool 120 may be used to confirm key distribution has successfully completed and request/record a Key Injection Status Table (KIST) 118 including vehicle identification number (VIN) to unique identifier (UID) pairings for downstream use. The process, accordingly, requires little interaction with the EOL tool 120 and the key constraint of cycle time containment is minimized by allowing the gateway 108 to manage the process with the ECUs 104 in the background.

The gateway 108 may perform the operations of a key generator and distributor. In support of these operations, the gateway 108 includes a hardware security module (HSM) 114 including a true random number generator for use in the generation of security keys. A HSM 114 refers to a physical computing device that safeguards and manages digital keys for strong authentication and provides cryptoprocessing. A true random number generator is a hardware component on a device that generates random numbers from a physical process, rather than from performing steps of a computer algorithm. In an example, the HSM 114 may utilize thermal noise or the photoelectric effect as the underlying physical phenomenon to sampler for the generation of numerical values.

Each of the ECUs 104 may include a HSM/Secure Hardware Extension (SHE) 116. Similar to as discussed above with respect to the gateway 108, the HSM/SHE 116 may be a physical computing device that safeguards and manages digital keys for strong authentication and provides cryptoproces sing. The ECUs 104 may receive the generated keys from the gateway 108, and may store the generated keys to the HSM/SHE 116. Accordingly, the HSM/SHE 116 may be configured to prevent reading and unauthorized writing to the value of the security keys.

As explained in greater detail below, the key distribution process may be performed per a two-layered protocol. An outer layer may be an On-Vehicle Telematics Protocol (OVTP) which defines how the gateway 108 communicates with other ECUs 104. An inner layer may be a SHE functional protocol which regulates how the ECU 104 host microcontroller communicates with the corresponding peripheral SHE/HSM 116 of the ECU 104, and which sequences enablement of secure key updating for the ECU 104.

The gateway 108 may host the KIST 118. The KIST 118 may maintain status information indicative of which keys have been injected onto which ECU 104 at what desired key slots. By using the KIST 118, EOL systems such as the EOL tool 120 can proof-check whether keys are injected to all desired key slots at all desired ECUs 104 on a vehicle 102.

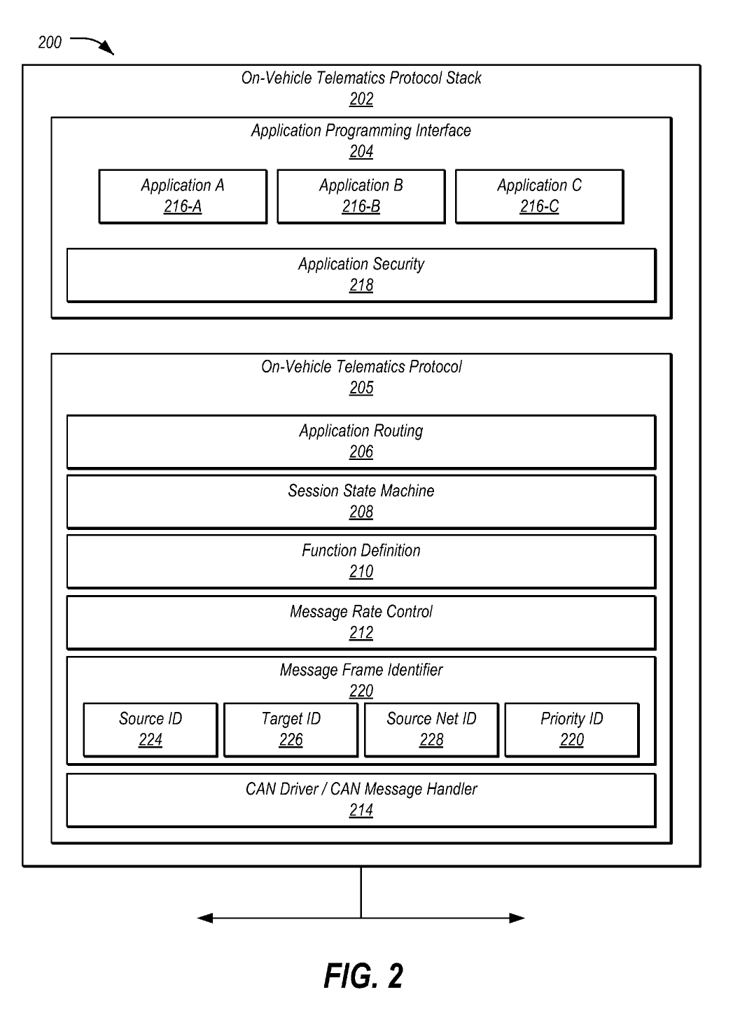

FIG. 2 shows an example implementation 200 of an OVTP protocol stack 202. Using the example implementation 200, the ECUs 104, 106 may be able to send and/or receive CAN messages including 29-bit message identifiers 220. The stack 202 may include an application programming interface (API) 204 and an OVTP protocol 205 having a plurality of networking software layers, such as, but not limited to, an application routing 206, a session state machine 208, a function definition 210, a message rate control 212, and a CAN driver 214.

Regarding CAN, a CAN message frame may include a plurality of fields, such as a start of frame (SOF) field, an arbitration field, a control field, a data field, a cyclic redundancy check (CRC) field, and an end of frame (EOF) field. The arbitration field may comprise a CAN message identifier bit string and a bit defining a message priority. The control field may include data defining the size of the data field. The ECUs 104 and/or the backbone controllers 106 receiving a given message frame may reference the control field to identify how much data is included. The data field may include a predefined amount of information, such as 8 bytes, 64 bytes, or any other amount. In some examples, the data field may also be empty, e.g., include 0 bytes of information, and may define a remote frame comprising a request for a data frame. Other possibilities for a size and value of the data field are also contemplated. The CRC field may assist in providing data integrity and the EOF field may provide a notification to the vehicle 102 bus that the message is complete.

The arbitration field is fixed for a particular message. Each message has a unique message identifier, though multiple of the same messages may be sent over CAN. In one example, a CAN database may store definitions of all messages for a particular bus. The ECUs 104 and the backbone controllers 106 on the network may be configured to access the CAN database for decoding the received message frames.

The priority identifier of the arbitration field may include a remote transmission request (RTR) bit. The RTR bit having a dominant state may designate a given message frame as a data frame and the RTR bit having a recessive state may designate a given message frame as a remote frame. The backbone controller 106 may send, to the ECU 104, the remote frame requesting a data frame having the same message identifier as the remote frame. The gateway 108 may, accordingly, be configured to identify that a given data frame (e.g., message frame whose RTR bit is in a dominant state) received from the source controller and intended for receipt by the target controller is sent in response to a previously transmitted remote frame, (e.g., message frame whose RTR bit is in a recessive state and whose message identifier matches the message identifier of the data frame).

In one example, the data field of a given CAN message frame may be 8 bytes long and may, therefore, limit sending message frames that are longer than a short string of characters or a single large number. The CAN messages defining data size that is larger than the data field may be separated into a plurality of CAN message frames. The individual CAN message frames may include values and bit locations within the original CAN message. The ECU 104 and the backbone controller 106 may be configured to, in response to receiving the CAN message frames, query the CAN database to identify the location of each of the frames in the CAN message.

Now referring more specifically to OVTP, each of a plurality of applications 216 (shown generally as elements 216-A through 216-C) of the API 204 may include software instructions configured to be executed by a processor (not shown) of the controller 104, 106. In one example, the application 216 may be configured to receive data captured by a sensor connected to or in communication with the ECUs 104, 106 and to send the received data to another one of the ECUs 104, 106 using a CAN message including, e.g., a 29-bit message identifier 220. The API 204 is, thereby, configured to facilitate CAN communication between the applications 216 specific to the ECUs 104, 106 and those of the other ECUs 104, 106 of the vehicle 102, as well as with one or more devices (not shown) remote to the vehicle 102. In another example, the API 204 may be further configured to secure CAN communication data flow to and from the applications 216 using an application security layer 218.

The applications 216 that utilize the OVTP protocol 205 may be configured to send and receive CAN message frames including a plurality of fields, such as, but not limited to, the SOF field, the arbitration field, the control field, the data field, the CRC field, the ACK field, and the EOF field. The arbitration field of an extended CAN message frame may include the 29-bit message identifier 220 and may prioritize which of the nodes attempting to send a message will control the bus of the vehicle 102.

In one example, the identifier 220 may comprise a source controller identifier 224, a target controller identifier 226, a source network identifier 228, and a priority identifier 230. The source controller identifier 224 may define the ECU 104, 106 sending the message, e.g., the source ECU 104, the target ECU identifier 226 may define the ECUs 104, 106 for which the message is intended, e.g., the target ECU 104, the source network identifier 228 may define the source network where the source ECU 104 is located, and the priority identifier 230 may define a priority of transmitting a given CAN message to the target ECU 104 relative to one or more vehicle 102 control signals.

The priority identifier 230 may define, for example, the priority of the messages relative to the diagnostic and control messages of the vehicle 102. As one example, the priority identifier 230 having a dominant state may designate a given message frame as a data frame and the priority identifier 230 having a recessive state may designate a given message frame as a remote frame. The gateway 108 may, accordingly, be configured to identify whether a given message frame is a data frame, e.g., message frame whose RTR bit is in a dominant state, or a remote frame, e.g., message frame whose RTR bit is in a recessive state. The gateway 108 may also be configured to identify, based on a combination of the priority identifier 230 state and detecting a match between corresponding message identifiers of the remote and data frames, that a given data frame has been sent in response to a previously transmitted remote frame.

The applications 216 of the ECUs 104 may include, as some examples, an over-the-air (OTA) application enabling interpretation of messages being routed under this application as OTA software update messages and route the messages to a corresponding OTA-capable application of the controller 104, 106, a PARSED request response application enabling each ECU 104, 106 to interpret messages being routed under this application as processing and reporting system for efficient data upload messages and route the messages to a corresponding application for handling, a PARSED push application that may include the functioning transmission of data based on an internal ECU 104, 106 event and may be performed only when the PARSED application has been properly configured by the request-response component of the PARSED application.

The source ECU identifier 224 may further define an originating ECU 104, 106 for the OVTP message. In one example, the source ECU identifiers 224 may further define ECU identifiers stored in a routing table maintained by the gateway 108. Source ECU identification 224 may allow multiple source ECUs 104 to exchange message frames with multiple target ECUs 104 simultaneously.

The target controller identifier 226 may define the ECUs 104, 106 for which the OVTP message is intended. In one example, for messages originating at a given ECU 104, 106, the target ECU identifier 226 may be defined as the target ECU 104 that is receiving the information being transmitted. In another example, the target ECU identifiers 226 may further define ECU identifiers stored in the routing table 208. Inclusion of this parameter may allow for a hardware routing numeric value to be applied to software abstraction layers in a controlled manner. As one example, the ECU 104, 106 detecting the CAN message may reference the target ECU identifier 226 at the physical layer to determine whether the detected CAN message is intended for this or for another ECU 104, thereby avoiding the protocol 205 layers above the physical layer having to process the detected CAN message in order to determine the intended recipient ECU 104, 106.

For example, a pair of ECUs 104, 106 on the vehicle 102, such as the ADAS 104-E and the TCU 106-A, may each be connected to a wireless network and may be configured to communicate using CAN messaging. Each of the ECUs 104, 106 may represent a unique subnet 110 and/or backbone 112 location defining a unique network address. The ECUs 104, 106 may, accordingly, send and receive messages at the same time without conflicts of message transmission on the physical wire of the network. This may also allow for addition of the connected ECUs 104, 106 without requiring architecture redesign.

The OVTP protocol 205 may use request-addressing such that a given ECU 104, 106 may interpret a received request in accordance with one or more predefined parameters included in the request, e.g., a remote frame including an RTR bit in a recessive state and indicating a request for a corresponding data frame including the RTR bit in a dominant state and the same message identifier. In one example, the protocol 205 defined on the ECU stack may be further configured to route a request to a particular application 216 of the ECU 104, 106 to which the request is directed (or which will handle the request).

The session state machine 208 may be configured to reject unsecure or improperly encrypted requests, to allow the ECU 104, 106 to release resources that may be in use for PARSED or OTA to other applications because a session is not active. The use of the state machine 208 may, accordingly, permit controlling bandwidth utilization of the vehicle 102 network remotely. The use of the state machine 208 may further provide a handshake requirement such that the server may confirm that the client is awake and ready to receive data.

The function definitions 210 may define functions that are utilized by various schema taking advantage of the 29-bit message identifier 220. For example, without limitation, over the air updates (OTA) have a defined set of available functions, and these function definition bits can reference a function associated with a message. The message rate control portion 212 may be configured to control transmission speed at which the one or more CAN frames defining a given OVTP message may be transmitted. The message rate control portion 212 may, accordingly, control a maximum bandwidth that will be used during a given transmission.

A given data message received by the gateway 108 may, accordingly, include the source controller identifier 224, e.g., 10 bits of the 29-bit message identifier 220, the target ECU identifier 226, e.g., 10 bits of the 29-bit message identifier 220, and the priority identifier 230, e.g., 3 bits of the 29-bit message identifier 220. The OVTP protocol 205 may further include the CAN driver 214 configured to perform CAN message handling, thus allowing the ECU 104, 106 to send and receive CAN messages, as well as push the CAN messages onto the vehicle 102 CAN bus.

The addressing components, instead of being hardcoded, as in some instances, may be designed as logical constructs and may facilitate the use of the 10 source bits and the overall 20 source/target bits. This may allow for an application that provides mesh-based networking of ECU 104, 106 messages across the entire network without conflict. This may also leverage the physical layers of the CAN protocol 205 design relative to other networks, which can allow for multiple senders and receivers on the same physical wire. The controller 104, 106 detecting the CAN message may reference the target controller identifier 226 at the physical layer to determine whether the detected CAN message is intended for this or for another ECU 104, 106 thereby avoiding the protocol layers above the physical layer having to process the detected CAN message intended for another ECU 104, 106.

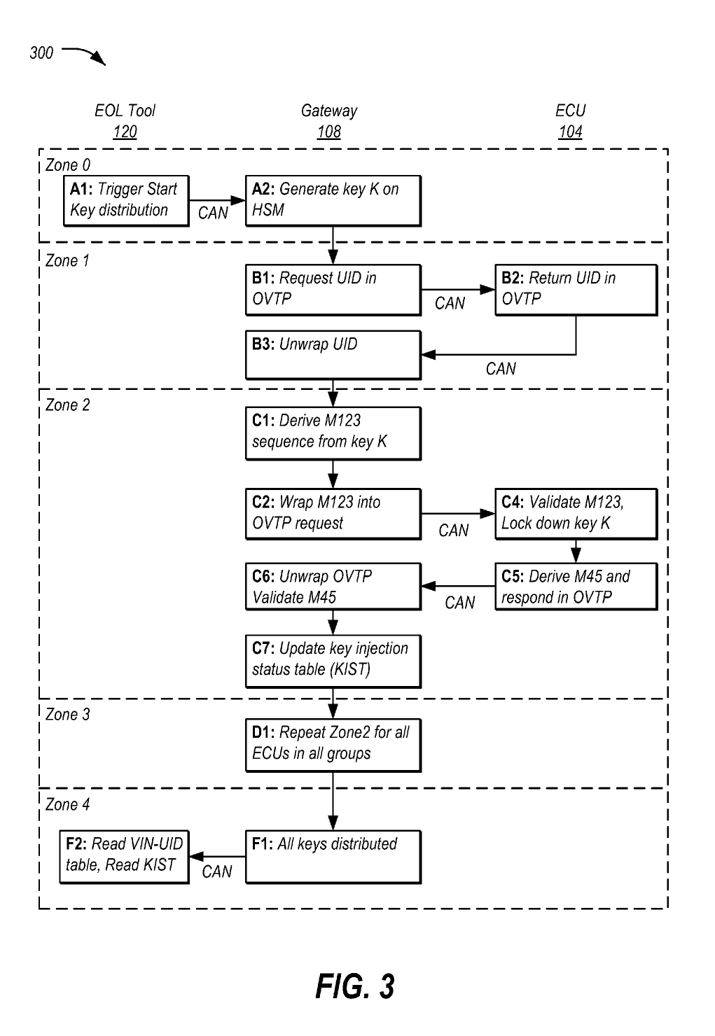

FIG. 3 illustrates an example process 300 for performing the secure key distribution. In an example, the process 300 may be performed using the system topology 100 and OVTP protocol 205 discussed in detail above.

In phase 1, referring to Task A1, an EOL tester tool may trigger the key distribution protocol. This may occur, in an example, at prerolls, with the EOL tester tool sending a diagnostic request to the gateway 108. At Task A2, responsive to receipt of the request, the gateway 108 calls the true random number generator functions of the HSM 114 and uses the resulting random sequence to create the key K.

In phase 2, referring to Task B1, the gateway 108 initiate the key distribution protocol and sends out the OVTP message to request the UID of the HSM/SHE 116 on a downstream ECU 104 in a pre-defined group for receiving keys. At Task B2, the downstream ECU 104 unwraps the OVTP message and forwards the UID request to its peripheral HSM/SHE 116 using the SHE protocol.

In phase 3, referring to Task B3, the gateway 108 unwraps the UID from an ECU 104. Referring to Task C1, after receiving the UID from the ECU 104, the gateway 108 prepares a sequence of M1, M2, and M3 (or in short M123) using SHE memory updating protocol. The M123 is a sequence that contains the UID of the ECU 104, the target key slot index and an authorization key slot index, the encrypted copy of the key K, and a message authentication code of all these items. It allows the ECU 104 to update the key slot to the value of the key K in a secure manner. At Task C2, the gateway 108 wraps the sequence into an OVTP request message and sends the sequence toward the target ECU 104.

In phase 4, referring to Task C4, the HSM/SHE 116 of the target ECU 104 validates the sequence M123. If the validation is successful, the HSM/SHE 116 returns a verification sequence M45 that is computed with the new key K. At Task C5, the target ECU 104 wraps the sequence M45 into an OVTP response and sends the sequence M45 as wrapped back to the gateway 108.

In phase 5, referring to Task C6, the gateway 108 validates the response message M45 after unwrapping the OVTP. If the sequence is successful, the gateway 108 confirms the key K has been successfully injected at the desired key slot on the desired ECU 104. Accordingly, at Task C7, the gateway 108 updates the KIST 118 to indicate successful delivery of the key K.

In phase 6, referring to Task D1, the gateway 108 further repeats phases 2 to 5 until all keys have been injected correctly. When key injection has been completed, the EOL tool 120 may read out the VIN-UID mapping and the KIST 118, to confirm which vehicle 102 has which ECUs 104 as well as to double-check that key injection was completed successfully.

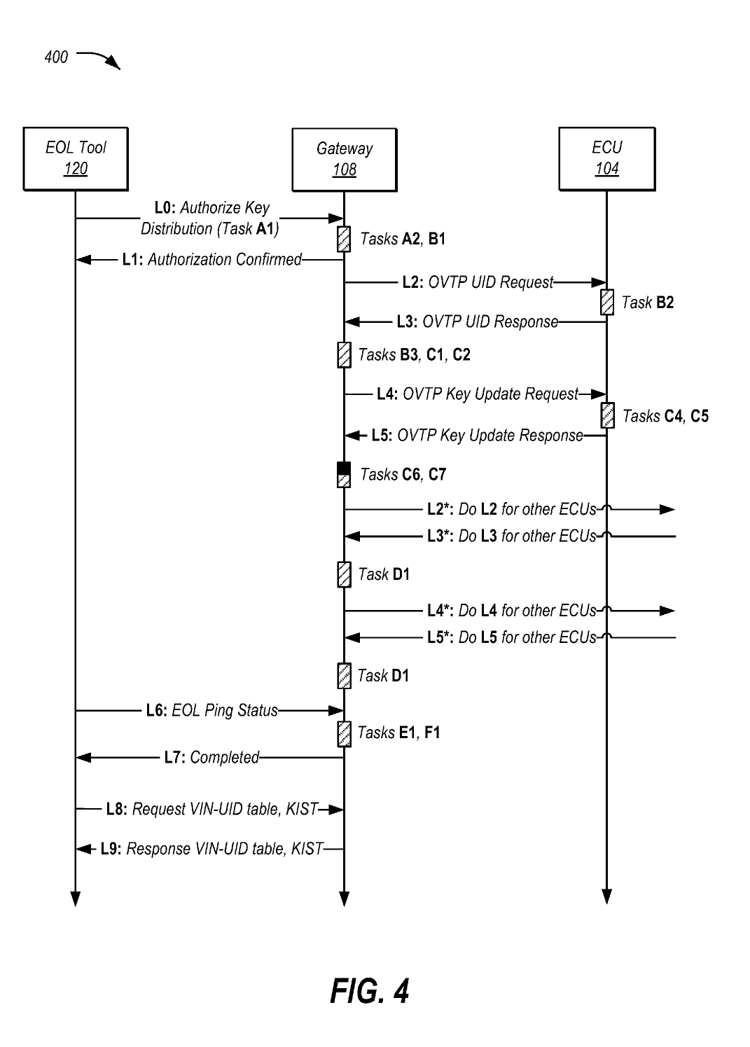

FIG. 4 illustrates an example data flow diagram 400 for performing the secure key distribution. In an example, the data flow diagram 400 may operate in accordance with the process 300 using the system topology 100 and OVTP protocol 205 discussed in detail above.

At L0, the EOL tool 120 authorizes key distribution in accordance with Task A1. Responsive to the authorization, the gateway 108 performs Tasks A2 and B1. Responsive to completion of Tasks A2 and B1, the EOL tool 120 sends confirmation of the authorization, which is received by the EOL tool 120 at L1.

At L2, the gateway 108 sends an OVTP UID request to the target ECU 104. Responsive to receipt of the request, the ECU 104 performs Task B2. Responsive to completion of Task B2, the ECU 104 sends an OVTP response which is received by the gateway 108 at L3. Responsive to receipt of the response, the gateway 108 performs Tasks B3, C1 and C2.

At L4, the gateway 108 sends an OVTP Key update request to the target ECU 104. Responsive to receipt of the request, the ECU 104 performs Tasks C4 and C5. Responsive to completion of Tasks C4 and C5, the ECU 104 sends an OVTP Key update response which is received by the gateway 108 at L5. Responsive to receipt of the response, the gateway 108 performs Tasks C6 and C7.

Notably, with respect to the illustrated Task D1, the operations L2, L3, L4, and L5 may be repeated for each of the target ECUs 104 to receive keys. It should be noted that the key distribution to the ECUs 104 may, in some examples, be performed sequentially, one ECU 104 at a time. In other examples, however, the key distribution to the ECUs 104 may overlap, such that some ECUs 104 are performing certain tasks of the process 300 concurrent with other ECUs 104 performing tasks of the process 300.

At L6, the EOL tool 120 sends a status ping to the gateway 108. Responsive to the ping, the gateway 108 performs Tasks E1 and F1. Responsive to completion of Tasks A2 and B1, at L7 the gateway 108 sends a completed response message to the EOL tool 120.

At L8, the EOL tool 120 sends a VIN-UID KIST 118 request to the gateway 108. Responsive to the request, the gateway 108 sends the KIST 118 to the EOL tool 120, which is received to the EOL tool 120 at L9, The EOL tool 120 may, accordingly, analyze the KIST 118 and ensure that the secure key distribution to the ECUs 104 was performed successfully.

Thus, by using the system topology 100, OVTP protocol 205, process 300, and data flow 400, an adversary may be unable to read keys on the gateway 108 during key generation, or on downstream ECUs 104 when keys are received and updated. Moreover, the adversary may be unable to learn the keys while they are being transmitted over CAN/CAN-FD/Ethernet/etc. Additionally, the keys may maintain 128-bit entropy which prevents the adversary attempting an exhaustive search of the key space. Yet further, the adversary may be unable to write keys to the downstream ECU 104.

Computing devices described herein, such as the ECUs 104, backbone controllers 106, gateway 108, and EOL tool 120, generally include computer-executable instructions where the instructions may be executable by one or more computing devices such as those listed above. Computer-executable instructions may be compiled or interpreted from computer programs created using a variety of programming languages and/or technologies, including, without limitation, and either alone or in combination, Java™, C, C++, C#, Visual Basic, JavaScript, Python, JavaScript, Perl, PL/SQL, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent upon reading the above description. The scope should be determined not with reference to the above description, but with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary in made herein. In particular, use of the singular articles such as “a,” “the,” “said,” etc. should be read to recite one or more of the indicated elements unless a claim recites an explicit limitation to the contrary.

The abstract of the disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A system comprising:
a gateway including a hardware security module (HSM) implementing a hardware random number generator and a non-transitory memory maintaining a key injection status table (KIST), programmed to
distribute keys generated using the random number generator to a plurality of electronic control units (ECUs) responsive to a trigger to begin key distribution received from an end-of-line (EOL) tool, and
send the KIST to the EOL tool responsive to completion of the key distribution.

2. The system of claim 1, wherein the gateway is further programmed to update the KIST responsive to receipt of confirmation from one of the plurality of ECUs that one of the keys has been successfully injected to a key slot of the one of the plurality of ECUs.

3. The system of claim 1, wherein the gateway is further programmed to:
request a unique identifier (UID) of one of the plurality of ECUs;
generate a key using the random number generator for the UID;
send the key to the one of the plurality of ECUs; and
update the KIST to indicate that the key was sent to the UID of the one of the plurality of ECUs.

4. The system of claim 1, wherein the gateway is further programmed to send a key to one of the plurality of ECUs utilizing a M123 sequence that includes (i) a UID of the one of the plurality of ECUs, (ii) a target key slot index of the one of the plurality of ECUs into which the key is to be placed, and (iii) an encrypted copy of the key.

5. The system of claim 4, wherein the gateway is further programmed to receive, in response to the M123 sequence, a M45 response that includes a verification of placement of the key that is computed using the key to be placed.

6. The system of claim 1, wherein the gateway is further programmed to send the KIST responsive to receipt of a KIST request message from the EOL tool.

7. A method comprising:
sending a key generated using a hardware random number generator in an encrypted message to a vehicle electronic control unit (ECU), responsive to receiving a unique identifier (UID) of the ECU over a vehicle bus; and
responsive to an indication of success from the ECU in a second encrypted message, updating a key injection status table (KIST) to indicate that the key was applied to the ECU.

8. The method of claim 7, further comprising:
requesting a second unique identifier (UID) of a second ECU over the vehicle bus;
generating a second key using the hardware random number generator;
sending the second key in a third encrypted message to the second ECU; and
responsive to an indication of success from the second ECU in a fourth encrypted message, updating the KIST to indicate that the second key was applied to the second ECU.

9. The method of claim 8, further comprising:
receiving a ping status message from an end-of-line (EOL) tool, and
sending the KIST to the EOL tool responsive to completion of key distribution to the ECU and the second ECU.

10. The method of claim 7, further comprising initiating key distribution to the ECU responsive to receipt of an authorization message from an end-of-line (EOL) tool.

11. The method of claim 7, further comprising including, in the encrypted message, (i) a UID of the ECU, (ii) a target key slot index of the ECU into which the key is to be placed, and (iii) an encrypted copy of the key.

12. The method of claim 11, further comprising receiving, in the second encrypted message, a verification of placement of the key that is computed using the key to be placed.

13. A system comprising:
a processor programmed to, responsive to an indication of success from an ECU in an encrypted response message received responsive to sending a key generated using a hardware random number generator in an encrypted request message to the ECU, update a key injection status table (KIST) to indicate that the key was applied to the ECU.

14. The system of claim 13, wherein the processor is further programmed to, responsive to receiving a unique identifier (UID) of a vehicle electronic control unit (ECU) over a vehicle bus, send the encrypted request message to the ECU.

15. The system of claim 13, wherein the processor is further programmed to distribute keys including the key to a plurality of electronic control units (ECUs) including the ECU, responsive to a trigger to begin key distribution received from an end-of-line (EOL) tool.

16. The system of claim 15, wherein the processor is further programmed to receive a ping status message from the end-of-line (EOL) tool, and send the KIST to the EOL tool responsive to completion of key distribution to a plurality of ECUs including the ECU.
